(19) United States
(12) Patent Application Publication
(10) Pub. No.: US 2026/0131393 A1
(43) Pub. Date: May 14, 2026

(54) SNAKE ROBOT FOR ELECTROCHEMICAL MACHINING

(71) Applicant: INTERNATIONAL BUSINESS MACHINES CORPORATION, ARMONK, NY (US)

(72) Inventors: Sarbajit Kumar Rakshit, Kolkata (IN); Sathya Santhar, Ramapuram (IN); Sridevi Kannan, Chennai (IN)

(21) Appl. No.: 18/942,956

(22) Filed: Nov. 11, 2024

(51) Int. Cl. B23H 7/26; B23H 3/10; B25J 9/06; B25J 15/00; B25J 19/00

(52) U.S. Cl. CPC B23H 7/26; B23H 3/10; B25J 9/065; B25J 15/0019; B25J 19/0029

(57) ABSTRACT

An apparatus for forming a curved drill hole in a workpiece by electrochemical machining (ECM). The apparatus includes, an ECM drill head, a snake robot and an insulative material surrounding the snake robot. The ECM drill head is attached to a first end of the snake robot. The snake robot includes a movement control assembly adapted to control movement of the snake robot and the ECM drill head attached thereto. The snake robot also includes a plurality of conduits extending within and along a length of the snake robot, including a first conduit of the plurality of conduits adapted to deliver an electrolyte solution to the ECM drill head and a second conduit of the plurality of conduits adapted to remove debris from the ECM drill head.

### BACKGROUND

The present disclosure relates to using robots for different activities. More particularly, the present disclosure relates to a snake robot used for different activities.

Robotics is an area of active research, and various types of robots have been developed for various activities. A snake-arm robot, or “snake robot,” is a computerized electro-mechanical device with many features found in industrial robotic arms. The “snake” description refers to the snake robot's long, generally cylindrical shape, which can move in ways that are reminiscent of a snake.

### SUMMARY

According to some embodiments of the disclosure, there is provided an apparatus for forming a curved drill hole in a workpiece by electrochemical machining (ECM). The apparatus includes, an ECM drill head, a snake robot and an insulative material surrounding the snake robot. The ECM drill head is attached to a first end of the snake robot. The snake robot includes a movement control assembly adapted to control movement of the snake robot and the ECM drill head attached thereto. The snake robot also includes a plurality of conduits extending within and along a length of the snake robot, including a first conduit of the plurality of conduits adapted to deliver an electrolyte solution to the ECM drill head and a second conduit of the plurality of conduits adapted to remove debris from the ECM drill head.

According to some embodiments of the disclosure, there is provided a system for drilling a curved drill hole in a workpiece using electrochemical machining (ECM). The system includes an apparatus for forming the curved drill hole in the workpiece by ECM. The apparatus includes an ECM drill head, a snake robot, wherein the ECM drill head is attached to a first end of the snake robot, and an insulative material surrounding the snake robot. The sake robot includes a movement control assembly adapted to control movement of the snake robot and the ECM drill head attached thereto, and a plurality of conduits extending within and along a length of the snake robot, including a first conduit of the plurality of conduits adapted to deliver an electrolyte solution to the ECM drill head and a second conduit of the plurality of conduits adapted to remove debris from the ECM drill head. The system also includes the electrolyte solution.

According to some embodiments of the disclosure, there is provided a method of performing electrochemical machining (ECM) to create a curved drill hole in a workpiece. One operation is identifying one or more dimensions of a desired curved drill hole in the workpiece, wherein the one or more dimensions are based on a specification. Another operation is, based on the one or more dimensions, selecting a snake robot adapted to move and provide physical support to an ECM drill head through the workpiece while performing ECM. A further operation is selecting the ECM drill head adapted to result in a desired cross-sectional shape of the desired curved drill hole. Yet another operation is providing a system including an apparatus for forming the curved drill hole in the workpiece by ECM. The apparatus includes the ECM drill head, the snake robot, wherein the ECM drill head is attached to a first end of the snake robot, an insulative material surrounding the snake robot, and the electrolyte solution. The snake robot includes a movement control assembly adapted to control movement of the snake robot and the ECM drill head attached thereto, and a plurality of conduits extending within and along a length of the snake robot, including a first conduit of the plurality of conduits adapted to deliver an electrolyte solution to the ECM drill head and a second conduit of the plurality of conduits adapted to remove debris from the ECM drill head. Another operation is drilling the workpiece using the system. A further operation is creating the curved drill hole.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a perspective view of a snake robot, in accordance with embodiments of the present disclosure.

FIG. 2 illustrates a snake robot shown drilling into a workpiece, shown in see-through view, resulting in a curved drill hole, in accordance with embodiments of the present disclosure.

FIG. 3 illustrates an embodiment of a system, in accordance with embodiments of the present disclosure.

FIG. 4 is a flow diagram of a method of performing electrochemical machining (ECM) to create a curved drill hole in a workpiece, in accordance with embodiments of the disclosure.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

Aspects of the present disclosure relate generally to using robots for certain activities. More particularly, the present disclosure provides a snake robot or a flexible robotic arm that can be used for certain activities, such as electrochemical machining (ECM). While the present disclosure is not necessarily limited to such applications, various aspects of the disclosure can be appreciated through a discussion of various examples using this context.

Electrochemical machining (ECM) is an advanced non-contact, non-thermal material removal process capable of small features, high quality surfaces, and high repeatability for production parts. Pulsed electrochemical machining (PECM), sometimes called precision electrochemical machining, is a newer, more precise variant of ECM that utilizes a pulsed power supply, but the fundamentals of ECM remain the same.

When discussing PECM there are some key terms that are used on a routine basis. A cathode represents a tool in a PECM process. It can be referred to as the tool, cathode, or electrode. In most cases, it is designed and manufactured for each specific application. Typically, the cathode is the inverse of the desired shape to be machined. An anode is used to refer to the workpiece or the material that will be dissolved away during the PECM process. The anode can take on many forms including, but not limited to wrought stock, a near net shape cast piece, a conventionally machined part, a three-dimensional (3D) printed or additively manufactured part, etc. An electrolyte is a working fluid in the PECM process, and it is flushed between the cathode and the anode. The electrolyte is typically a salt-based solution that serves two purposes. One, it allows electrical current to flow between the cathode and anode. Two, it flushes away the by-products of the electrochemical process including metal hydroxides of the dissolved metals. A gap, otherwise known as an interelectrode gap (IEG), is a space that is maintained between the cathode and the anode during the machining process. In electrochemical machining, the gap is a major contributor to the performance of the process. The introduction of PECM has allowed for gap sizes on the order of 10 to 100 micrometers (μm) (0.0004 to 0.004 inches) and ultimately the ability to resolve much smaller features in the final workpiece. In ECM, a workpiece is immersed in an electrolyte and connected to a positive terminal of a low-voltage, high-current direct current (DC) power supply while a tool electrode, a negative of a desired shape, is immersed at some distance (gap size) from the workpiece and connected to a negative terminal.

A snake robot (or “snake arm robot” or “flexible robotic arm”) is a type of robotic design inspired by the movement and structure of snakes. It typically consists of multiple articulated segments, mimicking the flexible and agile motion of a snake. These robots can move in a variety of environments, including confined spaces and uneven terrain, making them useful for tasks such as search and rescue, exploration, and inspection in hazardous or hard-to-reach areas. Snake robots can be, for example, tendon-driven or pneumatically controlled. Snake robots are often used in association with another device. The function of the other device can be to control the snake robots, for example.

In the formation of various instruments or machines, curved drill holes in, for example, complex geometry objects can be necessary. For example, in medical instruments, automobiles, and aircraft, proper and precise curvature of curve drilling, if a workpiece requires the creation of a complex contour drill hole, conventional drilling tools are not suitable for achieving this task. Therefore, a method and system are needed to enable the creation of complex drill holes on any workpiece. The present disclosure provides embodiments in which a snake robot can create curved drill holes using ECM or PECM.

Embodiments of the present disclosure relate to a method for creating curved drill holes with a snake robot or a flexible robotic arm. The method can include mounting an ECM drilling head on a tip of the snake robot or the flexible robotic arm, which can be covered with an appropriate insulation layer. The method can further include analyzing a profile and a diameter of a curved drill hole from design specifications. The method can also include navigating the ECM drilling head mounted on the snake robot or the flexible robotic arm in order to maintain a desired curvature profile during a drilling process. The snake robot or the flexible robotic arm can provide physical stability and support to the ECM drilling head for increased accuracy in drilling operations. The method can also include tracking or detecting, with an attached sensor installed in the ECM drilling head, a rate of material removal to ensure a desired gap is maintained for ECM. Further, the method can include synchronizing the movement of the snake robot or the flexible robotic arm with the ECM drilling head based on the rate of material removal. The method can include identifying changes in the diameter or profile dimensions of the curved drill hole in order to determine when to replace the ECM drilling head on the snake robot or the flexible robotic arm. The method can also include retracting the ECM drilling head from the curved drill hole to replace the ECM drilling head with a different ECM drilling head when desired. The method can also include circulating fresh electrolyte and removing material through a hollow passage within the snake robot or the flexible robotic arm to ensure uninterrupted curved drilling operations.

Embodiments of the present disclosure relate to a method of using a system including a snake robot or a flexible robotic arm with an insulation layer around its body, which can mount an ECM drilling head. The method can enable precise navigation of the ECM drilling head for creating an accurate curved drill hole on a workpiece. The method can include analyzing design specifications to maintain curvature profiles during drilling. The flexible robotic arm or the snake robot can provide stability and support of the ECM drilling head for accurate curved drilling execution. The method can use a sensor-equipped ECM drilling head that tracks material removal rates, ensures optimal gap maintenance for seamless ECM. The sensor-equipped ECM drilling head can be synchronized with the flexible robotic arm or the snake robot movement along with the curved drill hole. The method can allow for adaptations based on changes in drill hole dimensions. The system can identify when to replace the ECM drilling head. The flexible robotic arm or the snake robot can perform movement. The ECM drill head can be replaced in order to ensure uninterrupted drilling operations with precise adjustments. The flexible robotic arm or the snake can include at least one hollow passage that can facilitate electrolyte circulation and debris removal, while ensuring uninterrupted and efficient curved drilling on a workpiece.

Embodiments of the present disclosure relate to an apparatus for forming a curved drill hole in a workpiece by ECM. The apparatus includes, an ECM drill head, a snake robot and an insulative material surrounding the snake robot. The ECM drill head is attached to a first end of the snake robot. The snake robot includes a movement control assembly adapted to control movement of the snake robot and the ECM drill head attached thereto. The snake robot also includes a plurality of conduits extending within and along a length of the snake robot, including a first conduit of the plurality of conduits adapted to deliver an electrolyte solution to the ECM drill head and a second conduit of the plurality of conduits adapted to remove debris from the ECM drill head.

Embodiments of the present disclosure relate to a system for drilling a curved drill hole in a workpiece using ECM. The system includes an apparatus for forming the curved drill hole in the workpiece by ECM. The apparatus includes an ECM drill head, a snake robot, wherein the ECM drill head is attached to a first end of the snake robot, and an insulative material surrounding the snake robot. The sake robot includes a movement control assembly adapted to control movement of the snake robot and the ECM drill head attached thereto, and a plurality of conduits extending within and along a length of the snake robot, including a first conduit of the plurality of conduits adapted to deliver an electrolyte solution to the ECM drill head and a second conduit of the plurality of conduits adapted to remove debris from the ECM drill head. The system also includes the electrolyte solution.

Embodiments of the present disclosure can advantageously form curved drill holes in a workpiece. Prior methods included casting the workpiece and forming it in multiple parts that are later attached together. The embodiments disclosed herein can advantageously reduce manufacturing costs and difficulty.

Embodiments of the present disclosure can advantageously include a flexible robotic arm or a snake robot with an ECM drilling head, which can analyze a profile and a diameter of a curved drill hole from design specifications. Accordingly, the flexible robotic arm or the snake robot can maintain a desired curvature profile while moving through the curved drill hole during the drilling process. Also, in embodiments of the present disclosure, the flexible robotic arm or the snake robot can advantageously provide physical stability and support to the ECM drilling head to execute drilling operations accurately. Embodiments of the present disclosure can advantageously include a sensor installed in the ECM drilling head that can track a rate of material removal and ensure that a desired gap is maintained for ECM. Advantageously, embodiments of the present disclosure can include movement of the flexible robotic arm or the snake robot that can be synchronized, enabling seamless curved drilling operations. Also, embodiments of the present disclosure can advantageously identify when to replace the ECM drilling head during the drilling process, based on changes in diameter or profile dimensions of a drill hole (such as circular, oval, square, etc. drill holes). Also, advantageously, embodiments of the present disclosure can include a system in which the flexible robotic arm or the snake robot can retract from the curved drill hole and retrieve a different ECM drilling head for continued operation.

For purposes of this disclosure, reference will be made to an illustrative snake robot or flexible robotic arm that is capable of ECM. Of course, the disclosure herein should not be considered to be limited to the illustrative examples depicted and described herein. With reference to the attached figures, various illustrative embodiments of the devices, systems and methods disclosed herein will now be described in more detail.

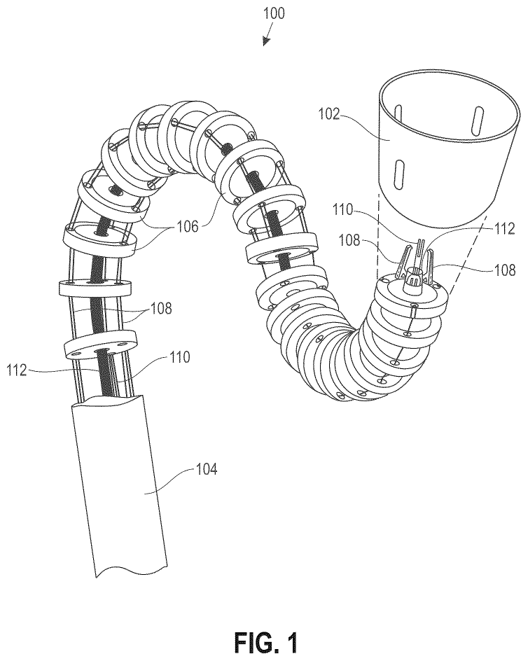

Turning to the figures, FIG. 1 is a perspective view of a snake robot 100 including a drill head 102 for ECM (shown detached) with an insulative covering 104 that is shown partially removed (in order to view components inside the snake robot 100), in accordance with embodiments of the present disclosure. The insulative covering 104 can be any non-conductive material, such as a plastic material, for example. The snake robot 100 includes a plurality of ribs 106 in a generally linear arrangement, when the snake robot 100 is in a linear arrangement. The plurality of ribs 106 can be moveable with respect to one another in order to allow the snake robot 100 to change its shape. The snake robot 100 as shown is in a curved or serpentine configuration. The plurality of ribs 106 are shown adjacent to one another and can be moveable with regard to one another using flexible joints (e.g., flexible rods, hinges, ball and socket joints, etc.) (not shown) or by using sets or bundles of control wires 108 (as shown) that run along the length of the snake robot 100, and therethrough the snake robot 100, and control movement of the snake robot 100.

The bundles of control wires 108 can extend through and between the plurality of ribs 106 in order to control movement of the plurality of ribs 106 and communicate movement instructions to the components of the snake robot 100. In general, the snake robot 100 can include a movement control assembly (not shown) for controlling movement of the snake robot 100. Any suitable movement control assembly is contemplated by the disclosure. Some examples include, without limitation, tendon-driven, motor-driven and pneumatically controlled assemblies. The movement control assembly can involve using control wires, rods and joints, for example, to move the snake robot 100 in a serpentine fashion. The movement control assembly can also control the drilling done by the drill head 102. An electrical supply through the bundles of control wires 108, for example, can extend through the length of the snake robot 100 to the drill head 102. Other methods of controlling the movement of the snake robot 100 are also contemplated by the disclosure.

Movement instructions for the plurality of ribs 106 can be remotely communicated to the snake robot 100 from a computer or other device, for example, and to a communication unit (not shown) within the snake robot 100. The communication unit can be connected to one or more wires included in the bundles of control wires 108 and can be connected to the movement control assembly physically or wirelessly. A computer or mobile device, for example, can communicate wirelessly with a base station, which in turn can connect with the internet.

The drill head 102 shown is one example of many possible drill heads that can be used with the snake robot 100. The drill head 102 shown includes a circular cross-sectional shape in order to form a drill hole with a circular cross-section. Other shapes of drill holes can be desired, and, accordingly, other shapes of drill heads are also contemplated by the present disclosure. For example, a rectangular drill hole can be desired. Also, possible drill heads that are contemplated by the present disclosure can include drill heads with varying dimensions. The drill head 102 shown is reversibly attachable and can be changed out with a different drill head (not shown) during a drilling operation as desired for fulfillment of the drilling operation.

The snake robot 100 can include one or more hollow passages that extend through a central portion and throughout and along its length. As shown, in the snake robot 100, there is included one example of an electrolyte conduit 110 being utilized for circulating fresh electrolyte through the snake robot 100 and to the drill head 102. Also, a debris removal conduit 112 is included in order to remove debris material, along with the electrolyte used in the drilling process, that has been removed by the drill head 102. The inclusion of the electrolyte conduit 110 and the debris removal conduit 112 allow for uninterrupted curved drilling on a workpiece. The conduits shown in FIG. 1 are examples, and other configurations and possibilities are also contemplated.

Alternatively, an ECM drilling head can be mounted on a flexible robotic arm, which is similar to a snake robot. Such a flexible robotic arm can also be covered with an appropriate insulation layer made of any insulative material that is flexible. A tip of the flexible robotic arm can also be equipped with the ECM drilling head. In this setup, the ECM drilling head will perform the drilling, while the flexible robotic arm can be utilized for precisely navigating the ECM drilling head in order to create accurate, curved drill holes. The flexible robotic arm can include one or more hollow conduits or passages throughout its length, being utilized for circulating fresh electrolyte and removing material removed by the ECM drilling head. When referring to a snake robot throughout the present disclosure, it is contemplated that a flexible robotic arm can be used interchangeably with the snake robot.

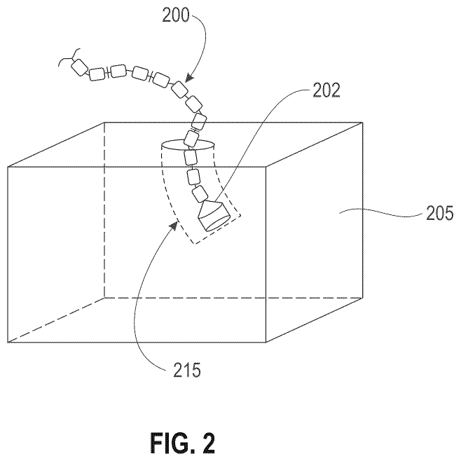

FIG. 2 illustrates a snake robot 200 (or a flexible robotic arm can be used) shown drilling into a workpiece 205, with the workpiece 205 being shown in see-through view, resulting in a curved drill hole 215, in accordance with embodiments of the present disclosure. Prior to drilling the curved drill hole 215, a desired design can be determined and analyzed in order to identify a desired curvature and diameter of the curved drill hole 215. A movement pattern of the snake robot 200 can be determined in order to result in the curved drill hole 215. The snake robot 200 can include a drill head 202 at one (distal) end that can cut or drill the curved drill hole 215. The snake robot 200 is not shown with an insulation layer surrounding and along its length in order to better view the snake robot 200, however one can be included. Such an insulation layer can be used to separate electrical components from an electrolyte solution used in drilling the curved drill hole 215. A central portion of the snake robot 200 can include at least one hollow passage that can include a conduit (not shown or visible) through which the electrolyte solution can flow to the drill head 202 to be used in ECM. Additionally, the snake robot 200 can include a conduit (not shown or visible) for removal of drilling debris from the drill head 202 end of the snake robot 200 back to a second end (proximal end) located outside the workpiece 205. Such debris can be generated during the drilling, or cutting, process.

A sensor (not shown or visible) can, for example, be attached to the snake robot 200. The sensor, or multiple sensors, can be used to measure cutting progress. The sensor can also control movement of the snake robot 200. During gradual ECM with the snake robot 200, the drill head 202 can gradually remove material of the workpiece 205 and can complete the curved drill hole 215.

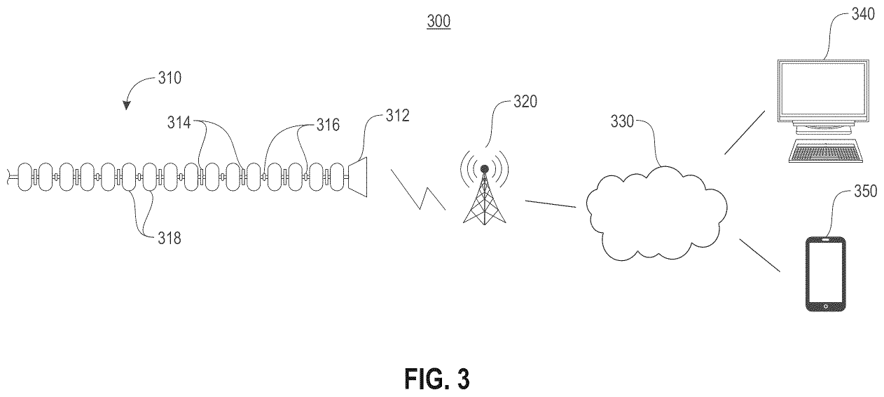

FIG. 3 illustrates an embodiment of a system 300, in accordance with embodiments of the present disclosure. System 300 depicts an overall architecture, and not all components are required for all embodiments. For example, in some embodiments of the system 300, a snake robot 310, including a drill head 312, for example, can be used for ECM of a workpiece (the workpiece not shown). The snake robot 310 shown is another example of a flexible robot that is contemplated by the present disclosure. The snake robot 310 is shown including a combination of ribs 314 and flexible joints 316 located between modules 318. The ribs 314 can be less flexible than the flexible joints 316. The flexible joints 316 can connect mutually adjacent modules of the modules 318 and can allow the modules 318 to move with respect to one another. The flexible joints 316 can be locked to add rigidity and can be unlocked in order to be flexible and allow for movement. Other suitable joints allowing a snake-like movement are also contemplated. Movement of the robot 310 can also include a driving movement of the robot 310, which allows for forward and reverse movement.

The snake robot 310 can be completely autonomous and may not require a command center 340 (e.g., a computer), and can be capable of carrying out a desired activity. The snake robot 310 can communicate wirelessly with a base station 320, which in turn can connect with an internet 330. The command center 340 and a mobile device 350 can be connected to the internet 330 and can communicate with one another and with the snake robot 310. The command center 340 and the mobile device 350 can alternatively be other suitable devices or controllers and are not limited to a computer and mobile phone, as shown.

Other systems are contemplated by the present disclosure that can include a snake robot, or flexible robotic arm, with a drill head, as described herein, that can be used for ECM. Additional components or alternative components to the ones described with regards to FIG. 3 are also contemplated by the present disclosure.

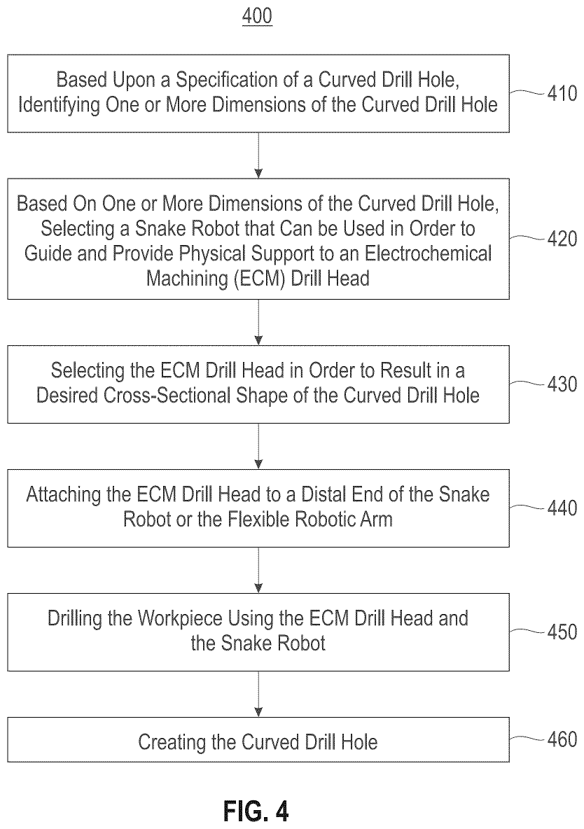

FIG. 4 is a flow diagram of a method 400 of performing ECM to create a curved drill hole in a workpiece, in accordance with embodiments of the disclosure. The method 400 includes an operation 410 of, based upon a specification of the curved drill hole, identifying one or more dimensions of the curved drill hole. The specification identifies the one or more dimensions that can include curvatures at different points along the curved drill hole, a diameter or diameters at different points along the curved drill hole, a length of the curved drill hole, an amount or amounts of curvature along the curved drill holes, etc. The method 400 further includes an operation 420 of, based on the one or more dimensions of the curved drill hole, selecting a snake robot or a flexible robotic arm that can be used in order to guide and provide physical support to an ECM drill head. The method 400 also includes an operation 430 of selecting the ECM drill head in order to result in a desired, cross-sectional shape of the curved drill hole. The method additionally includes an operation 440 of attaching the ECM drill head to a distal end of the snake robot or the flexible robotic arm. The snake robot or the flexible robotic arm can include conduits running throughout and along its length in order to move electrolyte solution to the ECM drill head and move debris produced by the ECM drill head away from the ECM drill head and out of the snake robot or the flexible robotic arm. The ECM drill head can receive controlled navigation and guidance from the snake robot or the flexible robotic arm. The method 400 also includes an operation 450 of drilling the workpiece using the ECM drill head and the snake robot. The snake robot can receive a trajectory (or movement path) of a drill path from a digital model of the workpiece. The digital model can identify how the snake robot or the flexible robotic arm needs to change the trajectory accordingly. The workpiece can be immersed into the electrolyte solution. The method includes ECM of the workpiece in order to result in the curved drill hole. The ECM includes removing debris using the ECM drill head and moving that debris material through the conduit for debris removal out of the snake robot or the flexible robotic arm. A vacuum could be used, for example, to remove the debris material. The method 400 also includes an operation 460 of creating the curved drill hole.

A sensor can be installed and utilized in the snake robot or the flexible robotic arm in order, during the method, to identify the progress of the electrochemical machining or drilling. The ECM drill head can be changed out as needed in order to form the curved drill hole. A computing system can send commands to the snake robot or the flexible robotic arm as it gradually moves and forms the curved drill hole. Based on a current position of the ECM drill head, and the snake robot, the snake robot can identify changes in curvature of the snake robot. The snake robot can calculate an amount of force that is desired in order to provide rigid support to the ECM drill head and can instruct ribs of the snake robot to provide desired angular alignment. Portions of the snake robot can also lock in order to provide the proper movement and forces during ECM of the curved drill hole. Based on progress of a curvature profile, during the method, the snake robot can gradually move and can create desired curvature aligned with the curvature of the curved drill hole. The curvature profile can be complicated. The snake robot can provide physical support to the ECM drill head and a pump can be attached to the snake robot in order to recycle electrolyte while debris from drilling is removed.

Embodiments of the present disclosure also relate to a method of performing ECM to create a curved drill hole in a workpiece. One operation is identifying one or more dimensions of a desired curved drill hole in the workpiece, wherein the one or more dimensions are based on a specification. Another operation is, based on the one or more dimensions, selecting a snake robot adapted to move and provide physical support to an ECM drill head through the workpiece while performing ECM. A further operation is selecting the ECM drill head adapted to result in a desired cross-sectional shape of the desired curved drill hole. Yet another operation is providing a system including an apparatus for forming the curved drill hole in the workpiece by ECM. The apparatus includes the ECM drill head, the snake robot, wherein the ECM drill head is attached to a first end of the snake robot, an insulative material surrounding the snake robot, and the electrolyte solution. The snake robot includes a movement control assembly adapted to control movement of the snake robot and the ECM drill head attached thereto, and a plurality of conduits extending within and along a length of the snake robot, including a first conduit of the plurality of conduits adapted to deliver an electrolyte solution to the ECM drill head and a second conduit of the plurality of conduits adapted to remove debris from the ECM drill head. Another operation is drilling the workpiece using the system. A further operation is creating the curved drill hole.

In the method, a snake robot can be fixed at one end, such as a proximal end, and the opposite end, such as a distal end, can include the ECM drill head and can be used for ECM of the workpiece. The snake robot can include a plurality of ribs that can change in relative orientation in order to change the shape of the snake robot for a drilling operation. The plurality of ribs in the snake robot can produce a force on a joining, or adjacent, rib. The force can be three-dimensional (3D), and can include, for example, a force generated by a pivotal rib, a force generated by the weight of each rib, and a force generated by pressure applied by electrolyte fluid on the ribs. The ribs in the snake robot can be oriented at an angle with regards to an adjacent rib. The angular directions of the different ribs can individually produce a resultant force, and the resultant forces can produce directional forces. Based on the orientation of the ribs, a system including the snake robot can calculate a relative angular orientation (or position) between the ribs and the same can be used for calculating a directional resultant force from the pivotal joints. A distance from each rib joined to a location of a resultant force can be calculated based on the relative angular orientation of different ribs. The distance can be converted to angular force components in order to calculate a resultant torque. Each of the applied forces or “resultant force” on each pivotal joint can be indicated as:

$${R}_{i} sin ( angle from different relative position ) \qquad ( 1 )$$

where i is equal to 1, 2, 3, 4, . . . 8, etc. The system can also calculate a distance from a fixed, proximal end of the snake robot, such as L1, L2, L3 . . . . The system can calculate torque at the fixed, proximal end of the snake robot, and the same can be aggregating the individual torque.

$$Torque = L 1 + Resultant Force 1 + L 2 + Resultant Force 2 + … \qquad ( 2 )$$

The snake robot can calculate a desired force strength to make the snake robot stable. A simulation process can be executed in order for different combinations of movement of the snake robot with different curvatures. A snake robot simulation engine can simulate different combinations of curvature on different directions of the snake robot.

For purposes of description herein, the terms “upper,” “lower,” “top,” “bottom,” “left,” “right,” “rear,” “front,” “vertical,” “horizontal,” and derivatives thereof shall relate to the devices as oriented in the figures. However, it is to be understood that the devices can assume various alternative orientations and operation sequences, except where expressly specified to the contrary. It is also to be understood that the specific devices and processes illustrated in the attached drawings, and described in the following disclosure, are simply exemplary embodiments of the inventive concepts defined in the appended claims. Hence, other physical characteristics relating to the embodiments disclosed herein are not to be considered as limiting, unless the claims expressly state otherwise.

For purposes of this description, certain aspects, advantages, and novel features of the embodiments of this disclosure are described herein. The disclosed processes, and systems should not be construed as being limiting in any way. Instead, the present disclosure is directed toward all novel and nonobvious features and aspects of the various disclosed embodiments, alone and in various combinations and sub-combinations with one another. The processes, and systems are not limited to any specific aspect or feature or combination thereof, nor do the disclosed embodiments require that any one or more specific advantages be present, or problems be solved.

Although the operations of some of the disclosed embodiments are described in a particular, sequential order for convenient presentation, it should be understood that this manner of description encompasses rearrangement, unless a particular ordering is required by specific language set forth below. For example, operations described sequentially can in some cases be rearranged or performed concurrently. Moreover, for the sake of simplicity, the attached figures may not show the various ways in which the disclosed processes can be used in conjunction with other processes. Additionally, the description sometimes uses terms like “provide” or “achieve” to describe the disclosed processes. These terms are high-level abstractions of the actual operations that are performed. The actual operations that correspond to these terms can vary depending on the particular implementation and are readily discernible by one of ordinary skill in the art.

As used in this application and in the claims, the singular forms “a,” “an,” and “the” include the plural forms unless the context clearly dictates otherwise. Additionally, the term “includes” means “comprises.”

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A apparatus for forming a curved drill hole in a workpiece by electrochemical machining (ECM), the apparatus comprising:
an ECM drill head;
a snake robot, wherein the ECM drill head is attached to a first end of the snake robot, the snake robot including:
a movement control assembly adapted to control movement of the snake robot and the ECM drill head attached thereto, and
a plurality of conduits extending within and along a length of the snake robot, including a first conduit of the plurality of conduits adapted to deliver an electrolyte solution to the ECM drill head and a second conduit of the plurality of conduits adapted to remove debris from the ECM drill head; and
an insulative material surrounding the snake robot.

2. The apparatus of claim 1, further comprising:
at least one control wire extending within and along the length of the snake robot to the ECM drill head and adapted to provide power to the ECM drill head.

3. The apparatus of claim 1, further comprising:
a pump adapted to move the electrolyte solution to the ECM drill head through the first conduit.

4. The apparatus of claim 1, wherein the snake robot includes a plurality of ribs adapted to allow the snake robot to change shape.

5. The apparatus of claim 1, wherein the ECM drill head includes a cross-sectional shape adapted to result in the curved drill hole having a desired shape.

6. The apparatus of claim 1, wherein the curved drill hole includes one or more dimensions that are based on a specification.

7. The apparatus of claim 1, wherein the snake robot is adapted to guide and provide physical support to the ECM drill head.

8. A system for drilling a curved drill hole in a workpiece using electrochemical machining (ECM), the system comprising:
an apparatus for forming the curved drill hole in the workpiece by ECM, the apparatus including:
an ECM drill head,
a snake robot, wherein the ECM drill head is attached to a first end of the snake robot, the snake robot including:
a movement control assembly adapted to control movement of the snake robot and the ECM drill head attached thereto, and
a plurality of conduits extending within and along a length of the snake robot, including a first conduit of the plurality of conduits adapted to deliver an electrolyte solution to the ECM drill head and a second conduit of the plurality of conduits adapted to remove debris from the ECM drill head, and
an insulative material surrounding the snake robot; and
the electrolyte solution.

9. The system of claim 8, further comprising:
a pump adapted to move the electrolyte solution to the ECM drill head through the first conduit.

10. The system of claim 8, wherein the snake robot includes at least one control wire extending therethrough to the ECM drill head and adapted to provide power to the ECM drill head.

11. The system of claim 8, wherein the snake robot includes a plurality of ribs adapted to allow the snake robot to change shape.

12. The system of claim 8, wherein the ECM drill head includes a cross-sectional shape adapted to result in the curved drill hole having a desired shape.

13. The system of claim 8, wherein the curved drill hole includes one or more dimensions that are based on a specification.

14. The system of claim 8, wherein the snake robot is adapted to guide and provide physical support to the ECM drill head.

15. A method of performing electrochemical machining (ECM) to create a curved drill hole in a workpiece, the method comprising:
identifying one or more dimensions of a desired curved drill hole in the workpiece, wherein the one or more dimensions are based on a specification;
based on the one or more dimensions, selecting a snake robot adapted to move and provide physical support to an ECM drill head through the workpiece while performing ECM;
selecting the ECM drill head adapted to result in a desired cross-sectional shape of the desired curved drill hole;
providing a system including:
an apparatus for forming the curved drill hole in the workpiece by ECM, the apparatus including:
the ECM drill head,
the snake robot, wherein the ECM drill head is attached to a first end of the snake robot, the snake robot including:
a movement control assembly adapted to control movement of the snake robot and the ECM drill head attached thereto, and
a plurality of conduits extending within and along a length of the snake robot, including a first conduit of the plurality of conduits adapted to deliver an electrolyte solution to the ECM drill head and a second conduit of the plurality of conduits adapted to remove debris from the ECM drill head, and
an insulative material surrounding the snake robot,
the electrolyte solution;
drilling the workpiece using the system; and
creating the curved drill hole.

16. The method of claim 15, further comprising:
attaching the ECM drill head to the snake robot.

17. The method of claim 15, further comprising:
receiving, by the snake robot, a trajectory of a drill path from a digital model of the workpiece.

18. The method of claim 15, further comprising:
removing the debris created during drilling.

19. The method of claim 15, further comprising:
delivering the electrolyte solution to the ECM drill head.

20. The method of claim 15, further comprising:
immersing the workpiece into the electrolyte solution.
